(19) United States
(12) Patent Application Publication
(10) Pub. No.: US 2026/0187829 A1
(43) Pub. Date: Jul. 2, 2026

(54) ANOMALY DETECTION METHOD, COMPUTER EQUIPMENT, AND COMPUTER-READABLE STORAGE MEDIUM

(71) Applicant: UBTECH ROBOTICS CORP LTD, Shenzhen (CN)

(72) Inventors: Chi Shao, Shenzhen (CN); Baiyu Pan, Shenzhen (CN); Jianxin Pang, Shenzhen (CN); Jichao Jiao, Shenzhen (CN)

(21) Appl. No.: 19/096,761

(22) Filed: Apr. 1, 2025

(30) Foreign Application Priority Data
Dec. 31, 2024 (CN) 202411999184.7

(51) Int. Cl. G06T 7/70; G06T 7/20

(52) U.S. Cl. CPC G06T 7/70; G06T 7/20

(57) ABSTRACT

An anomaly detection method, a computer equipment, and a computer-readable storage medium are provided. The method includes: obtaining sensor data to determine a first identification of a to-be-detected object from the sensor data and a first rotation angle of a detection box of the to-be-detected object; obtaining a first dictionary; determining a third rotation angle set corresponding to the first identification based on second rotation angle sets in the first dictionary; determining a reference rotation angle corresponding to the first identification based on the third rotation angle set, in response to a number of elements of the third rotation angle set being larger than a first number threshold; and obtaining a detection result of the first rotation angle by performing an anomaly detection on the first rotation angle based on the reference rotation angle. In this manner, anomaly detection of rotation angle is realized.

### CROSS REFERENCE TO RELATED APPLICATIONS

The present disclosure claims priority to Chinese Patent Application No. 202411999184.7, filed Dec. 31, 2024, which is hereby incorporated by reference herein as if set forth in its entirety.

### TECHNICAL FIELD

The present disclosure relates to computer vision, and particularly to an anomaly detection method, a computer equipment, and a computer-readable storage medium.

### BACKGROUND

3D (three-dimensional) object detection is a kind of important task in the field of computer vision. The main goal of 3D object detection is to detect and locate an object in a three-dimensional space and accurately obtain geometric information such as the size, position and orientation of the object. 3D object detection can detect the actual size and orientation of the object, which helps to fully comprehend the scene as a whole. For example, in the field of autonomous driving, 3D object detection can provide vehicles with obstacle recognition, motion prediction and environmental understanding; and in the field of robots, 3D object detection can achieve more accurate environmental interaction and navigation by helping robots to avoid dynamic and static obstacles, providing input information for robotic arms to plan the grab path by detecting the position and direction of objects, and helping robots to adjust their paths and tasks in a timely manner by detecting the position changes of multiple objects.

However, among the existing 3D object detection methods, there is a common problem that the detection results are low in accuracy.

### BRIEF DESCRIPTION OF DRAWINGS

FIG. 1 is a schematic diagram of the network architecture of an anomaly detection system 100 according to an embodiment of the present disclosure.

FIG. 2 is a schematic diagram of the structure of a server 400 according to an embodiment of the present disclosure.

FIG. 3 is a flow chart of the first example of anomaly detection method according to an embodiment of the present disclosure.

FIG. 4 is a flow chart of determining a reference rotation angle according to an embodiment of the present disclosure.

FIG. 5 is a flow chart of determining a first angle difference according to an embodiment of the present disclosure.

FIG. 6 is a flow chart of the second example of anomaly detection method according to an embodiment of the present disclosure.

FIG. 7A is a schematic diagram of displaying a detection box in a lidar point cloud according to an embodiment of the present disclosure.

FIG. 7B is a schematic diagram of displaying a detection box in a camera image according to an embodiment of the present disclosure.

FIG. 8A is a schematic diagram of displaying a detection box in a correct rotation angle according to an embodiment of the present disclosure.

FIG. 8B is a schematic diagram of displaying a detection box in a wrong rotation angle according to an embodiment of the present disclosure.

FIG. 9 is a schematic diagram of the distribution of the angles of a detection box according to an embodiment of the present disclosure.

It should be pointed out that the above-mentioned “first” and “second” are only used to distinguish different solutions, and do not represent the degree of superiority or inferiority of the solutions or the priority in the implementation process.

### DETAILED DESCRIPTION

In order to make the purpose, technical solutions and advantages of the present disclosure clearer, it will be further described in detail below in conjunction with the drawings. The described embodiments should not be regarded as limitations of the present disclosure, and all other embodiments obtained by those skilled in the art, under the premise of no creative labor, will fall within the scope of the protection of the present disclosure.

In the following descriptions, “some embodiments” are involved, which describe a subset of all possible embodiments. It should be noted that “some embodiments” may refer to the same subset or different subset of all possible embodiments, which can be combined with each other when there is no conflict.

In the following descriptions, the involved terms “first”, “second”, “third”, and the like are merely for differentiating similar objects and do not represent a specific order for the objects. It should be noted that the specific order or sequence of “first”, “second”, “third”, and the like may be interchanged under certain conditions so that the embodiments of the present disclosure described herein may be implemented in an order other than those illustrated or described herein.

In the embodiments of the present disclosure, the term “module” or “unit” refers to a computer program or part of a computer program with preset functions and works with other related parts to achieve predetermined goals and may be implemented by using software, hardware (e.g., processing circuit or storage) or a combination thereof in whole or in part. Likewise, a processor (or a plurality of processors or storages) may be used to implement one or more modules or units. In addition, each module or unit may be part of an integral module or unit containing the function of the module or unit.

Unless otherwise defined, all technical and scientific terms used in the embodiments of the present disclosure have the same meaning as commonly understood by those skilled in the art. The terms used in the embodiments of the present disclosure are merely for describing the embodiments of the present disclosure rather than limiting them.

In the embodiments of the present disclosure, the relevant data collection and processing should be strictly based on the requirements of relevant laws and regulations and obtain the informed consent or separate consent of the subject of personal information, and should carry out subsequent data use and process within the scope of the authorization of laws, regulations, and the subject of personal information.

Before further detailed description of the embodiments of the present disclosure, the involved nouns and terms will be described as follows.

1) “3D object detection” is based on object detection, not only identifying the position of an object, but also three-dimensional spatial information of the object such as depth and height. “3D object detection” includes identifying and positioning an object, and obtaining depth information and three-dimensional shape of the object. In which, identifying and positioning the object refers to identifying the object in three-dimensional space and determining the position and size of the object. Except for x and y coordinates in a two-dimensional image, it is also necessary to infer the z-coordinate of each object, that is, the depth information which is the distance of the object with respect to the camera.

3D object detection may be applied to scenarios such as autonomous driving, robot navigation, augmented reality, and virtual reality. The method to realize 3D object detection usually involves deep learning technology, which may extract features from sensor data (e.g., image or point cloud data) using convolutional neural networks (CNNs) or other neural network architectures, and may combine multiple sensor data (e.g., radar data and lidar data) to improve the accuracy of detection.

2) “3D multi-object tracking” refers to the process of tracking multiple dynamic objects simultaneously in three-dimensional space. 3D multi-object tracking not only includes the position change of an object in the horizontal direction (i.e., x and y coordinates), but also includes its depth change in the vertical direction (i.e., z coordinate). 3D multi-object tracking involves the key points including three-dimensional information, multi-objects, real-time, tracking algorithms, \data sources, and the like.

The application areas of 3D multi-object tracking include autonomous driving, robots, video surveillance, virtual reality, augmented reality, and the like. In the foregoing application areas, accurate three-dimensional tracking is crucial to understanding the scenario and providing decision supports.

3) “3D bounding box”—in 3D object detection—is a spatial representation method, which is used to describe the position, size, and orientation of an object in three-dimensional space. For example, the detection box may be a three-dimensional rectangle (i.e., box) used to distinguish an object from its environment to help with subsequent perception, tracking and planning tasks.

A 3D detection box is a geometric shape used to represent the boundaries of a target object, which has the purpose to accurately describe the position, size and orientation of the object in three-dimensional space. The parameters of the detection box include position, dimensions, orientation, category, and confidence. In which, the position is used to describe the coordinates of the center point of the object in three-dimensional space, which is usually represented using a world coordinate system or a sensor coordinate system. The dimensions represent the length, width and height of the detection box corresponding to (l, w, h), which describe the range of the object in three axial directions. The orientation is used to describe the rotation angle of the detection box, which is generally represented as a yaw angle about the vertical axis (i.e., Z axis). The detection box further includes object category tag such as vehicle, pedestrian, and bicycle. The confidence is a score for the detection box, which is used to indicate the confidence level of a model for its detection result.

The main function of the 3D detection box is to provide accurate spatial positioning information for the target object. Therefore, the 3D detection box may be used for object perception, collision detection and obstacle avoidance, multi-object tracking, and behavior prediction.

In three-dimensional space, the 3D detection box is usually displayed in the form of transparent wireframe to visually view the position and boundaries of the object. The 3D detection box consists of 8 vertices, which define the boundaries of a cuboid, and the connection between the vertices forms the boundary line of the detection box.

The 3D detection box is a cuboid that describes the boundaries of the target object in three-dimensional space, which is used to accurately indicate the position, size and orientation of the object. The 3D object detection box is the core output in a three-dimensional object detection task, providing necessary geometric information for subsequent tasks in application scenarios such as autonomous driving and robot navigation.

4) “[A]ngle of detection box”—in 3D object detection—refers to a predicted rotation direction of a 3D bounding box relative to a certain reference coordinate system. This angle describes the orientation of the bounding box, which is usually used to indicate the deflection of the object in the horizontal direction (e.g., the travel direction of vehicle) and other possible rotations.

Generally, the angle of detection box may include a yaw angle, a pitch angle, and a roll angle. In which, the yaw angle represents the rotation of an object about the vertical axis (usually the z-axis), which is the most commonly used angle in autonomous driving and robot scenarios because most objects (e.g., vehicles and pedestrians) are mainly move or be positioned on the horizontal plane. The yaw angle is in units of radians or degrees, and the range is usually (−π, π) or (0, 2π). The pitch angle indicates the rotation of an object about the horizontal axis (usually the y-axis), which is used to describe whether the object has an up/down tilt (e.g., a flying aircraft or an up/down hill vehicle). The roll angle indicates the rotation of an object about another horizontal axis (usually the x-axis), which describes whether the object has rolled (e.g., a dumped cargo box or a vehicle rollover).

The angle of the detection box helps to more accurately describe the direction and position of the object in space. The bounding box not only needs to wrap the object closely, but also needs to match the real direction of the object, such as the front and rear orientation of a vehicle. Through the angle information, the algorithm can distinguish the motion direction the rest state of an object to enhance the semantic understanding of the scene. The angle of the detection box can provide an accurate input for downstream tasks such as trajectory prediction or behavioral analysis.

5) “[R]otation angle”—in 3D object detection—refers to the orientation of a detection box in three-dimensional space, which usually represents the rotation information of the detection box relative to a certain reference coordinate system. The rotation angle of the detection box usually refers to the degree of deflection of the main axis direction of an object relative to the z-axis.

In order to better understand an anomaly detection method provided by the embodiments of the present disclosure, the disadvantages in the related technologies will be described first.

In related technologies, although 3D object detection has made significant progress in many fields, it faces great difficulty in learning the rotation angle of object, resulting in inaccurate prediction of rotation angles. In those existing technologies, the rotation angles obtained by predictions will be used directly without anomaly detection, that is, the existing technologies lack the anomaly detection method for rotation angles.

In the embodiments of the present disclosure, the anomaly detection method, a computer equipment, and a computer-readable storage medium are provided, which can realize anomaly detection for rotation angles. The following describes an exemplary application of the computer equipment provided by the embodiments of the present disclosure. The provided computer equipment provided may be implemented as any type of terminal like a laptop, a tablet, a desktop computer, a set-top box, a smartphone, a smart speaker, a smart watch, a smart TV, an unmanned vehicle, a drone, a smart robot, an aircraft, and a robotic arm, and may also be implemented as a server. As follows, the exemplary application when the computer equipment is implemented as a server will be described.

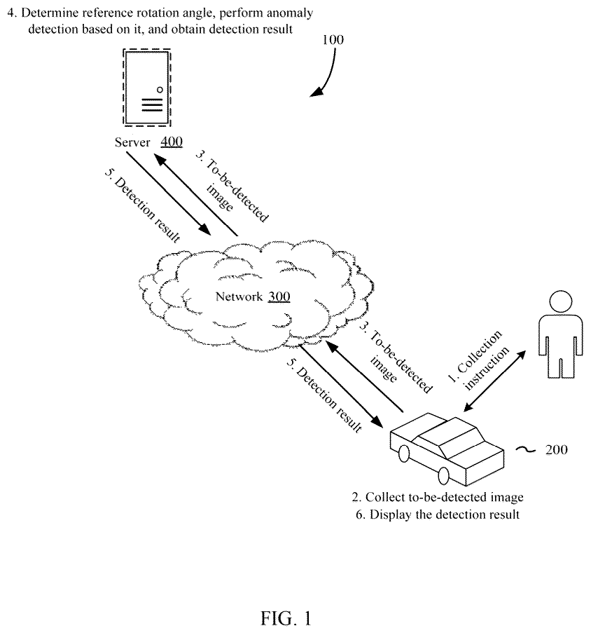

FIG. 1 is a schematic diagram of the network architecture of an anomaly detection system 100 according to an embodiment of the present disclosure. As shown in FIG. 1, in the anomaly detection system 100, in order to realize an anomaly detection application, a terminal 200 connects to a server 400 through a network 300 which may be a wide area network, a local area network, or a combination of the two.

The terminal 200 is configured to receive collection instructions regarding a to-be-detected object, collect sensor data like to-be-detected image(s), and send the to-be-detected image(s) to the server 400. The server 400 is configured to determine a first identification of a to-be-detected object in the to-be-detected image and a first rotation angle of a detection box of the to-be-detected object; obtain a first dictionary, where the first dictionary includes M second identifications, M second rotation angle set each corresponding to each of the second identifications, and the second rotation angle set includes second rotation angles corresponding to different timestamps; determine a third rotation angle set corresponding to the first identification based on the M second rotation angle sets in the first dictionary; determine a reference rotation angle corresponding to the first identification based on the third rotation angle set, in response to a number of elements of the third rotation angle set being larger than a first number threshold; and obtain a detection result of the first rotation angle by performing an anomaly detection on the first rotation angle based on the reference rotation angle. The server 400 may further return the detection result to the terminal 200 so that the terminal 200 displays the detection result. Taking the terminal 200 as an unmanned vehicle as an example, the terminal 200 may further perform path planning based on the detection result.

In this embodiment, for the first identification of the to-be-detected object in the to-be-detected image, the server 400 first determines the third rotation angle set corresponding to the first identification from the M second rotation angle set of the first dictionary, and then determines the reference rotation angle corresponding to the first identification from each third rotation angle set, in response to a number of elements of the third rotation angle set being larger than the first number threshold. Since the third rotation angle set includes third rotation angles, it is equivalent to determine the reference rotation angle corresponding to the first identification from the plurality of third rotation angles when the number of the third rotation angles is larger than the first number threshold, thereby improving the accuracy of the reference rotation angle. Based on this, the reference rotation angle is used to detect anomalies of the first rotation angle. In which, the first rotation angle is the rotation angle of the detection box of the to-be-detected object in the to-be-detected image. Since the reference rotation angle has the characteristics of high accuracy, it is possible to achieve efficient and accurate anomaly detection based on the reference rotation angle, thereby identifying whether the first rotation angle is normal or not through anomaly detection, and providing accurate data support for subsequent applications such as autonomous driving, navigation, or augmented reality.

In some embodiments, when there is an image collection module deployed on the server 400, the server 400 may collect the to-be-detected image based on its own image collection module.

In some embodiments, the server 400 may be a stand-alone physical server, or a server cluster or distributed system composed of multiple physical servers, or may also be a cloud server providing cloud service, cloud database, cloud computing, cloud function, cloud storage, network service, cloud communication, middleware service, domain name service, security service, content delivery network (CDN), and basic cloud computing service such as big data and artificial intelligence platform. The terminal 200 and the server 400 may be connected directly or indirectly through wired or wireless communication.

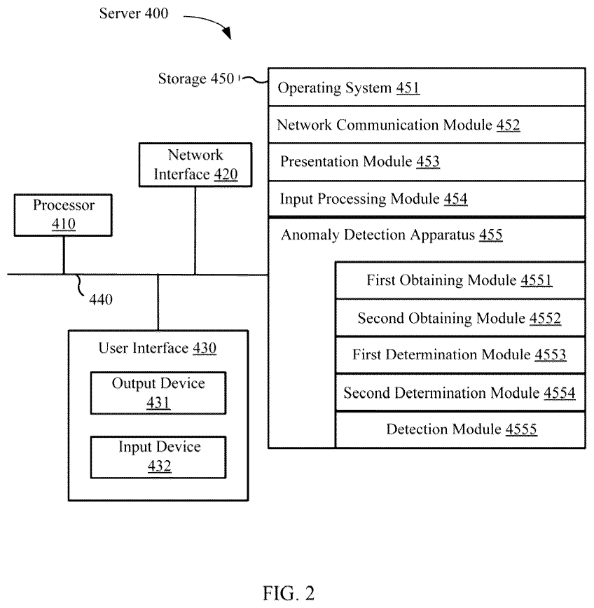

FIG. 2 is a schematic diagram of the structure of the server 400 according to an embodiment of the present disclosure. As shown in FIG. 2, the server 400 may include at least one processor 410, a storage 450, at least one network interface 420, and a user interface 430, where the foregoing components of the server 400 are coupled together through a bus system 440 that is for realizing connection communication between the components. The bus system 440 may include, in addition to a data bus, a power bus, a control bus, and a status signal bus. Though, for clarity, the various buses are merely marked as the bus system 440 in FIG. 2.

The processor 410 may be an integrated circuit chip with signal processing capabilities, which may be, for example, a general-purpose processor, a digital signal processor (DSP), or other programmable logic device, discrete gate or transistor logic device, discrete hardware component, or the like. In which, the general-purpose processor may be a microprocessor, any conventional processor, or the like.

The user interface 430 may include one or more output devices 431 for presenting media contents, which may include one or more speakers and/or one or more visual displays. The user interface 430 may further include one or more input devices 432, which may include user interface component that facilitate user input, such as keyboard, mouse, microphone, touch screen display, camera, other input button and control.

The storage 450 may be removable, non-removable, or a combination thereof. For example, the storage 450 may include solid state memory, hard disk drive, optical disk drive, or the like. The storage 450 may optionally include one or more storage devices physically located away from the processor 410.

The storage 450 may include volatile memory, nonvolatile memory, or both. The nonvolatile memory may be read-only memory (ROM), and the volatile memory may be random access memory (RAM). In this embodiment, the storage 450 is intended to include any suitable type of storages.

In some embodiments, the storage 450 is able to store data to support various operations. The data may include, for example, programs, modules, data structures, or subsets or supersets thereof, as described below.

An operating system 451 including system programs for processing various basic system services and performing hardware-related tasks, such as framework layer, core library layer, and driver layer that are for realizing various basic services and processing hardware-based tasks.

A network communication module 452 configured to reach other electronic devices via the (wired or wireless) network interfaces 420. For example, the network interface 420 may include Bluetooth, wireless compatibility authentication (Wi-Fi), universal serial bus (USB), and the like.

A presentation module 453 configured to present information through one or more output devices 431 (e.g., display screen and speaker) associated with the user interface 430, for example, a user interface for operating peripherals and displaying content and information.

An input processing module 454 configured to detect and translate user inputs or interactions from the one or more input devices 432.

In some embodiments, the apparatus provided by the embodiments of the present disclosure may be implemented in software. As shown in FIG. 2, there is an anomaly detection apparatus 455 stored in the storage 450, which may be a software in the form of program, plug-in, or the like that may include software modules namely a first obtaining module 4551, a second obtaining module 4552, a first determination module 4553, a second determination module 4554, and a detection module 4555. These modules are logical, so any combination or further disassembly may be performed according to the functions to be implemented. The functions of each module will be described below.

In other embodiments, the apparatus provided by the embodiments of the present disclosure may be implemented in hardware, and as an example, the apparatus may be a processor in the form of a hardware decoding processor that is programmed to execute the anomaly detection method provided by the embodiments of the present disclosure. For example, the hardware decoding processor may adopt one or more application specific integrated circuits (ASICs), DSPs, programmable logic devices (PLDs), complex programmable logic devices (CPLDs), field-programmable gate arrays (FPGAs), or other electronic components.

In some embodiments, the server 400 may implement the anomaly detection method provided by the embodiments of the present disclosure by executing various computer-executable instructions or computer programs. For example, the computer-executable instructions may be micro-program-level commands, machine instructions, or software instructions. The computer programs may be native programs or software modules in the operating system 451, may also be native application (APP), that is, the programs that need to be installed in the operating system 451 to execute, such as anomaly detection APP or target recognition APP, or may be a mini program that can be embedded in any APP, that is, a program that can be execute by just downloading it to the browser environment. In summary, the above-mentioned computer executable instructions may be any form of instructions, application, module, or plug-in.

The anomaly detection method provided by the embodiments of the present disclosure will be described in conjunction with the exemplary application and implementation of the server 400 provided by the embodiments of the present disclosure.

As mentioned above, the computer equipment that implements the anomaly detection method of the embodiments of the present disclosure may be a terminal, a server, or a combination of the two. Therefore, the subject of executing each step of the anomaly detection method will not be repeated hereafter.

It should be noted that in the following example of the anomaly detection method, the rotation angle is used as an example of yaw angle. According to the similar understanding, those skilled in the art can apply the anomaly detection method provided by the embodiments of the present disclosure to detect the anomaly of other angles such as pitch angle and roll angle. The anomaly detection method may also be applied to various scenarios including autonomous driving, robot navigation, augmented reality, virtual reality, mixed reality, industrial automation, logistics and warehousing, medical equipment and health industries, home services, artificial intelligence, and the like.

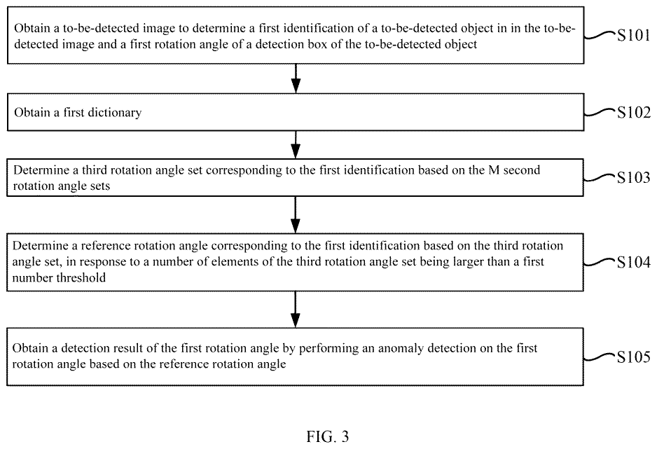

FIG. 3 is a flow chart of the first example of anomaly detection method according to an embodiment of the present disclosure. As shown in FIG. 3, in this embodiment, an anomaly detection method may include the following steps, where the subject to execute these steps may be a server.

S101: obtaining a to-be-detected image to determine a first identification of a to-be-detected object in the to-be-detected image and a first rotation angle of a detection box of the to-be-detected object.

In some embodiments, the to-be-detected image may be at least one image, that is, the number of images to be detected may be one or more. The to-be-detected image may be a 2D image or a 3D image. When there are a plurality of to-be-detected images, the to-be-detected images may include both 2D and 3D images. In which, the 2D image such as a photo of a vehicle on the road does not include depth information of the to-be-detected object, and the 3D image is composed of points in three-dimensional space, which can reflect the three-dimensional shape and position of the to-be-detected object. For example, the 3D image may be a point cloud image generated using lidar. In which, the to-be-detected object may include pedestrian, vehicle, road, traffic sign, building, and the like.

In some embodiments, the first rotation angle of the detection box of the to-be-detected object in the to-be-detected image may be determined through a 3D object detection method. Based on this, it may further determine the first identification of the to-be-detected object in the to-be-detected image through a 3D multi-object tracking method.

In some embodiments, the above-mentioned “3D object detection method determines the first rotation angle of the detection box of the to-be-detected object in the to-be-detected image” indicates that the rotation angle of the detection box—usually the yaw angle—may be determined through a 3D object detection algorithm. The first rotation angle is one of the important parameters of the detection box, describing the direction information of the object. Then, based on the detection result of the 3D object detection, the first identification of the to-be-detected object is determined through the 3D multi-object tracking, that is, the detected to-be-detected object and its detection box are further input into a 3D multi-object tracking algorithm, and the tracking algorithm assigns a unique ID (identification) for distinguishing and continuously tracking the to-be-detected object (by, for example, maintaining the same ID for the same car in multiple frames of image) to each to-be-detected object.

In some embodiments, the purpose of the 3D object detection method may be to detect the to-be-detected object from input data in a single frame (e.g., a point cloud image or a 2D image) and generate a 3D detection box and related information (e.g., position, dimensions, category, and orientation). The 3D object detection method may include a lidar point cloud-based detection method, a camera image-based detection method, and a multi-sensor fusion method. In which, the lidar point cloud-based detection method may adopt at least one of voxel-based method, point-based method, and hybrid method, the camera image-based detection method may adopt at least one of monocular 3D object detection and dual 3D object detection, and the multi-sensor fusion method refers to fusing the inputs from a variety of sensors such as lidar, camera, and radar, combining geometric information and semantic features to improve detection accuracy and robustness. For example, the multi-sensor fusion method may be AVOD or PointFusion.

In some embodiments, the 3D multi-object tracking method is to determine a unique ID of each to-be-detected object based on the historical trajectory of the object and the current detection result, and estimate its continuous motion trajectory. The 3D multi-object tracking method may include at least one of a target matching method, a state estimation method, a feature fusion method, a deep learning method, and the like.

S102: obtaining a first dictionary.

In this embodiment, the first dictionary may include M second identifications and M second rotation angle set each corresponding to each of the second identifications. In which, the second rotation angle set may include second rotation angles corresponding to different timestamps.

In some embodiments, the M second identifications may be stored in the first dictionary in the form of keywords, and the second rotation angle sets may be stored in the first dictionary in the form of values. In which, the M second identifications may be the identifications of the to-be-detected object obtained by the above-mentioned 3D multi-object tracking method, and the second rotation angle may be the rotation angle of the detection box of the to-be-detected object obtained by the above-mentioned 3D object detection method, where M is a positive integer which represents the number of the to-be-detected objects identified within a preset time threshold (e.g., 2 seconds), for example, 5, 8, 15, or the like.

In some embodiments, the server itself may store the first dictionary, hence the first dictionary may be obtained from the storage space of the server based on the storage location of the first dictionary, where the storage location may be a custom memory space location, or be a default memory space location.

In some embodiments, before executing the above-mentioned step S102, the first dictionary may be obtained first. In which, the first dictionary may be obtained by: obtaining a second dictionary, where the second dictionary corresponds to a timestamp before obtaining the to-be-detected image; storing the first identification as a keyword in the second dictionary; and obtaining the first dictionary by storing the first rotation angle as a value in the second dictionary.

In some embodiments, the second dictionary may refer to a dictionary corresponding to the previous timestamp in which the first identification and the first rotation angle determined in the above-mentioned step S101 have not been stored therein. Based on this, after the above-mentioned step S101, the first identification and the first rotation angle may be stored into the second dictionary to obtain the first dictionary.

In some embodiments, the implemented process of “storing the first identification and the first rotation angle into the second dictionary” may include storing the first identification as a keyword to the second dictionary, and storing the first rotation angle as the value to the second dictionary. Then, the storing the first identification as a keyword to the second dictionary, and storing the first rotation angle as the value to the second dictionary may be realized by: determining whether the keywords in the second dictionary include the first identification; using the first rotation angle as the value of the first identification—as the keyword—and storing the first rotation angle into the second dictionary to obtain the first dictionary in response to the keywords in the second dictionary include the first identification, and creating a new keyword and determining the first identification as the newly created keyword in response to the keywords in the second dictionary does not include the first identification; and using the first rotation angle as the value of the first identification—as the keyword—and storing the first rotation angle into the second dictionary to obtain the first dictionary.

In some embodiments, an empty initial dictionary may be created first. After each historical image is obtained, the historical identification and historical rotation angle of the to-be-detected object in the historical image may be determined, and the historical identification and historical rotation angle may be stored into the initial dictionary to obtain the second dictionary.

In some embodiments, to ensure the validity of the second identification and the second rotation angle in the first dictionary, the first dictionary may be updated in the following three ways, as described in detail below.

In the first update method, it may obtain for each of the second identifications, a first timestamp that corresponds to each of the second rotation angles corresponding to the second identification, in response to a second number of the second rotation angles corresponding to the second identification being larger than a second number threshold; obtain sorted rotation angles by sorting the second rotation angles in an order of the first timestamp from small to large; and obtain the first dictionary after updated by deleting the first L second rotation angles in the sorted rotation angles from the first dictionary, where L is a positive integer.

In some embodiments, in order to improve the efficiency of determining the reference rotation angle, and to control memory usage and improve search efficiency, when the second number of the second rotation angle corresponding to the second identification is larger than the second number threshold, the two rotation angles may be deleted to obtain the updated first dictionary so that the second number of the second rotation angles corresponding to each second identification does not exceed the second number threshold. In which, the second number threshold may be a value set in advance according to experience, for example, 20, 25, 30, or the like.

In some embodiments, the first timestamp corresponding to the second rotation angle may refer to the timestamp of the historical image corresponding to the second rotation angle, that is, the first timestamp corresponds to the moment when the historical image corresponding to the second rotation angle is collected. Based on this, the above-mentioned “obtain sorted rotation angles by sorting the second rotation angles in an order of the first timestamp from small to large” may be sorting the second rotation angles in order from earliest to latest according to the first timestamp to obtain the sorted rotation angles. Then, the first L second rotation angle in the sorted rotation angles may be deleted to obtain the updated first dictionary, where Lis a positive integer. In which, L may be the difference between the second number and the second number threshold. For example, assuming that the second number is 25 and the second number threshold is 20, L will be 5, that is, the first 5 second rotation angles in the sorted rotation angle are deleted to obtain the updated first dictionary, and the number of the second rotation angles corresponding to the second identification in the updated first dictionary is 20. In this manner, the second rotation angles that obtained earlier is deleted, thereby ensuring the timeliness of the updated first dictionary.

In some embodiments, the current first dictionary may be kept unchanged in response to the second number being less than or equal to the second number threshold.

In the second update method, it may obtain the updated first dictionary by deleting the second rotation angle corresponding to the third timestamp from the first dictionary in response to there being a third timestamp in the first timestamps that has a time interval larger than a time threshold with respect to the current timestamp.

In some embodiments, the time interval may be obtained by differentiating the current timestamp from each first timestamp, and the first timestamp corresponding to the time interval may be determined as the third timestamp in response to the time interval being larger than the time threshold to remove the second rotation angles corresponding to the third timestamp from the first dictionary. In which, the time threshold may be a value set in advance according to experience. For example, the time threshold may be 2 seconds, 2.5 seconds, 3 seconds, or the like. Taking the time threshold of 2 seconds, for instance, it will delete the second rotation angles that correspond to the timestamp with the time interval larger than 2 seconds with respect to the current timestamp, thereby ensuring the timeliness of the first dictionary.

In the third update method, it may obtain, for each of the second identifications, a second timestamp that corresponds to each of the second rotation angles corresponding to the second identification; determine a maximum timestamp among the second timestamps corresponding to the second rotation angles; and obtain the first dictionary after updated by deleting the second identification and the second rotation angles corresponding to the second identification from the first dictionary, in response to a time interval between the maximum timestamp and a current timestamp being larger than a time threshold.

In some embodiments, the above-mentioned maximum timestamp may refer to the latest or newest second timestamp. Based on this, if the time interval between the maximum timestamp and the current timestamp is larger than the time threshold, it indicates that the time interval between each of the second timestamp and the current time are all larger than the time threshold, and all the second rotation angles are considered to be invalid rotation angles, that is, the second identification does not correspond to a valid second rotation angle. Then, it may delete not only all the second rotation angles corresponding the second identification from the first dictionary, but also delete the second identification, thereby ensuring the timeliness of the first dictionary.

S103: determining a third rotation angle set corresponding to the first identification based on the M second rotation angle sets.

In some embodiments, the M second rotation angle sets may correspond to the M second identifications, that is, each second rotation angle set may correspond to a second identification, and the M second identifications include the first identification since the first identification and the first rotation angle have been stored into the first dictionary. Based on this, the first identification may be first determined from the second identification based on the first identification, and then the second rotation angle set corresponding to the first identification may be determined as the third rotation angle set, where the third rotation angle set includes at least one third rotation angle.

S104: determining a reference rotation angle corresponding to the first identification based on the third rotation angle set, in response to a number of elements of the third rotation angle set being larger than a first number threshold.

In some embodiments, the number of elements of the third rotation angle set may be the number of the third rotation angles in the third rotation angle set. When the number of elements is larger than the first number threshold, it indicates that the number of third rotation angles in the third rotation angle set is sufficient and diverse, then the reference rotation angle corresponding to the first identification may be determined based on the third rotation angle set. Otherwise, when the number of elements is less than or equal to the first number threshold, it indicates that the number of third rotation angles in the third rotation angle set is scarce and monotonous, then the process is ended. In which, the first number threshold may be a value set in advance according to experience, which is smaller than the above-mentioned second number threshold, for example, 9, 10, 11, or the like.

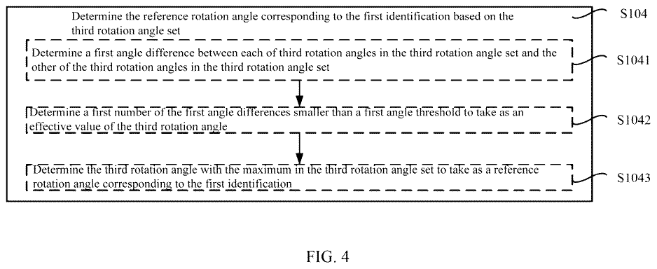

FIG. 4 is a flow chart of determining a reference rotation angle according to an embodiment of the present disclosure. In some embodiments, as shown in FIG. 4, the determining the reference rotation angle corresponding to the first identification based on the third rotation angle set in the above-mentioned step S104 may include sub-steps S1041-S1043, which will be described in detail below.

S1041: determining a first angle difference between each of third rotation angles in the third rotation angle set and the other of the third rotation angles in the third rotation angle set.

As in the foregoing examples, assuming that the first number threshold is 9 and the number of elements is 10, it indicates that the third rotation angle set includes 10 third rotation angles. Based on this, for each third rotation angle, the first angle difference between the third rotation angle and the other of the third rotation angles in the third rotation angle set are determined. If the other of the third rotation angles in the third rotation angle set include 9 other third rotation angles, the determining the first angle difference between each of third rotation angles in the third rotation angle set and the other of the third rotation angles in the third rotation angle set means determining the first angle difference between each of the other of the third rotation angles and the other of the third rotation angles, thereby determining the 9 first angle differences.

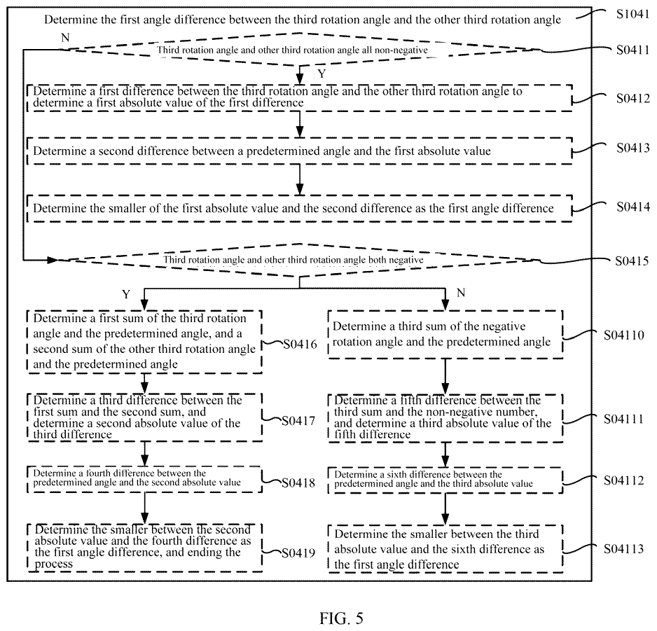

FIG. 5 is a flow chart of determining a first angle difference according to an embodiment of the present disclosure. As shown in FIG. 5, in some embodiments, taking only one other third rotation angle as an example, the determining the first angle difference between each of third rotation angles in the third rotation angle set and the other of the third rotation angles in the third rotation angle set in the above-mentioned step S1041 may be realized through the following sub-steps S0411-S0413, which will be described in detail below.

S0411: determining whether the third rotation angle and the other third rotation angle are all non-negative.

In some embodiments, the third rotation angle and the other third rotation angle all refer to angles, that is, the third rotation angle and the other of the third rotation angle are all numerical values. Taking the third rotation angle as an example, it may determine the numerical relationship between the third rotation angle and 0. If the third rotation angle is larger than or equal to 0, it determines that the third rotation angle is non-negative; otherwise, if the third rotation angle is less than 0, it determines that the third rotation angle is negative.

In some embodiments, if the third rotation angle and the other third rotation angle are non-negative, it proceeds to step S0412; otherwise, if the third rotation angle and the other third rotation angle are not both non-negative, it proceeds to step S0415.

S0412: determining a first difference between the third rotation angle and the other third rotation angle to determine a first absolute value of the first difference, in response to the third rotation angle and the other third rotation angle being both non-negative.

In some embodiments, if the first difference is negative, the opposite number of the first difference may be determined as the first absolute value. For example, assuming that the third rotation angle is 2.45 and the other third rotation angle is 2.57, the first difference between the third rotation angle and the other of the third rotation angle is −0.12, then 0.12 is determined as the first absolute value; and if the first difference is non-negative, the first difference is determined as the first absolute value.

S0413: determining a second difference between a predetermined angle and the first absolute value.

In some embodiments, the predetermined angle may be a value set in advance. When the angle direction is not taken into account, the predetermined angle may be set to 3.14; otherwise, when the angle direction is taken into account, the predetermined angle may be set to 6.28. In this embodiment, the predetermined angle is set to 3.14.

As in the foregoing examples, assuming that the first absolute value is 0.12 and the predetermined angle is 3.14, 3.02 is determined as the second difference.

S0414: determining the smaller of the first absolute value and the second difference as the first angle difference.

As in the foregoing examples, assuming that the first absolute value is 0.12 and the second difference is 3.02, 0.12 is determined as the first angle difference

The above-mentioned steps S0412-S0414 may be implemented through an equation of:

$$first angle difference = min ( abs ( a - b ) , 3.14 - abs ( a - b ) ) \qquad ( 1 )$$

In the forgoing equation (1), a represents the third rotation angle, b represents the other third rotation angle, abs(.) represents the absolute value, and min(.) represents the smaller value.

S0415: determining whether the third rotation angle and the other third rotation angle are both negative.

In some embodiments, when the third rotation angle and the other third rotation angle are non-negative, it proceeds step S0416; otherwise, when the third rotation angle and the other of the third rotation angle are not all negative, it indicates that one them is negative while the other of them is non-negative, then it proceeds step S04110.

S0416: determining a first sum of the third rotation angle and the predetermined angle, and a second sum of the other third rotation angle and the predetermined angle.

As in the foregoing examples, the sum of the third rotation angle and 3.14 is determined as the first sum, and the sum of the other third rotation angle and 3.14 is determined as the second sum.

S0417: determining a third difference between the first sum and the second sum, and determining a second absolute value of the third difference.

In some embodiments, the implemented process of step S0417 is similar to that of step S0412, so the implemented process of step S0417 can refer to that of step S0412.

S0418: determining a fourth difference between the predetermined angle and the second absolute value

In some embodiments, the implemented process of step S0418 is similar to that of step S0413, so the implemented process of step S0418 can refer to that of step S0413.

S0419: determining the smaller between the second absolute value and the fourth difference as the first angle difference, and ending the process.

In some embodiments, the implemented process of step S0419 is similar to that of step S0414, so the implemented process of step S0419 can refer to that of step S0414.

The above-mentioned steps S0416-S0419 may be realized through an equation of:

$$first angle difference = min ( abs ( ( 3.14 + a ) - ( 3.14 + b ) ) , 3.14 - abs ( ( 3.14 + a ) - ( 3.14 + b ) ) ) \qquad ( 2 )$$

In the forgoing equation (2), a represents the third rotation angle, b represents the other third rotation angle, abs(.) represents the absolute value, and min(.) represents the smaller value.

S04110: determining a third sum of the negative rotation angle and the predetermined angle.

In which, one of the third rotation angle and the other third rotation angle is negative and the other is non-negative. As in the foregoing examples, it determines the sum of the negative rotation angle and 3.14 as the third sum.

S04111: determining a fifth difference between the third sum and the non-negative number, and determining a third absolute value of the fifth difference.

In some embodiments, the implemented process of step S04111 is similar to that of step S0412, so the implemented process of step S04111 can refer to that of step S0412.

S04112: determining a sixth difference between the predetermined angle and the third absolute value.

In some embodiments, the implemented process of step S04112 is similar to that of step S0413, so the implemented process of step S04112 can refer to that of step S0413.

S04113: determining the smaller between the third absolute value and the sixth difference as the first angle difference

In some embodiments, the implemented process of step S04113 is similar to that of step S0414, so the implemented process of step S04113 can refer to that of step S0414.

Taking the third rotation angle as negative while the other third rotation angle as non-negative as am example, the above-mentioned steps S04110-S04113 may be realized through an equation of:

$$first angle difference = min ( abs ( 3.14 + a ) - b ) , 3.14 - abs ( ( 3.14 + a ) - b ) ) \qquad ( 3 )$$

In the forgoing equation (3), a represents the third rotation angle, b represents the remaining third rotation angle, abs(.) represents the absolute value, and min(.) represents the smaller value.

Through the foregoing steps S041-S04113, the third rotation angle is usually calculated in circumferential space, and its range is periodic (e.g., [0, 2π) or [−π, π)). Direct comparison of the third rotation angles may lead to errors or inconsistencies. In this embodiment, the consistency of the first angle difference in the periodic space can be ensured because, by using the absolute values and the predetermined angles (3.14 corresponds to 180°), the first angle difference is normalized to the smallest value, the correct first angle difference can be determined regardless of the symbol or size of the third rotation angle. The third rotation angle may be positive or negative, and the meaning of the symbol could be ignored by directly determining the first angle difference, resulting in an incorrect result. In this embodiment, the symbol or size of the third rotation angle is processed by case, which ensures that symbol differences will not affect the final result by the clever transformation of adding or subtracting the predetermined angle. The first angle difference is determined using the predetermined angle and the absolute value, and the smaller result is selected from the two possible values to ensure that the final angle difference is the shortest path. In addition, errors or conflicts caused by extreme values or boundary values are also avoided, thereby improving the stability and reliability of the calculation process.

Continue to refer to FIG. 4, descriptions after the above-mentioned step S1041 will be made.

S1042: determining a first number of the first angle differences smaller than a first angle threshold to take as an effective value of the third rotation angle.

In some embodiments, the first angle threshold may be a value set in advance according to experience. For example, the first angle threshold may be set to 0.15, 0.13, 0.1, or the like. When the first angle difference is smaller than the first angle threshold, it is considered that the two third rotation angles are the same or approximately the same. As in the foregoing examples, assuming that the first angle difference between the third rotation angle Y1 and the other of the third rotation angles is 0.16, 0.13, 0.12, 0.3, 0.02, 0.05, 0.11, 0.22, and 0.06, respectively, and the first angle threshold is 0.15, then 6 is determined as the first number and also determined as the effective value of the third rotation angle.

S1043: determining the third rotation angle with the maximum in the third rotation angle set to take as a reference rotation angle corresponding to the first identification.

In some embodiments, as in the foregoing examples, it is assumed that the third rotation angle set includes the third rotation angles Y1-Y10, and the effective values of the third rotation angles Y1-Y10 are 6, 4, 5, 8, 7, 3, 2, 4, 6, and 5, respectively, then the third rotation angle Y4 is determined as the reference rotation angle corresponding to the first identification.

In the above-mentioned steps S1041-S1043, since the angles in the third rotation angle set may deviate due to noise or the affections of multiple objects, the most representative third rotation angle is selected as the reference rotation angle to reduce the error. By determining the first angle difference between each third rotation angle and the other of the third rotation angles, the third rotation angle with the largest effective value is selected by filtering to ensure that the selected reference rotation angle is globally representative. Through the filtering of the “first angle threshold”, the “effective value” of each third rotation angle is determined. The noise points are naturally excluded due to the large deviation and cannot meet the threshold conditions. In the case of anomaly data or uneven distribution of third rotation angles, simply selecting the mean or median may lose their representativeness. Therefore, by selecting the third rotation angle with the largest effective value, different data distributions can be adapted to avoid the interference of a few anomaly data. Since the third rotation angle corresponding to the maximum effective value is often the most densely distributed part, it can automatically adapt to different objects or distribution patterns, thereby enhancing the flexibility of algorithm. The first angle threshold may be adjusted according to specific needs, thereby controlling the filtering range of effective values and adapting to different application scenarios. Through the logic of “maximum effective value”, the basis for selecting the reference angle is clarified, making the results easier to understand and accept. The method of determining the effective value of each third rotation angle is simple and can be completed in just one traversal. The calculation overhead is small, and it is suitable for the scenarios with high real-time requirements.

Continue to refer to FIG. 3, descriptions after the above-mentioned step S104 will be made.

S105: obtaining a detection result of the first rotation angle by performing an anomaly detection on the first rotation angle based on the reference rotation angle.

In some embodiments, the implemented process of step S105 may include: determining a second angle difference between the first rotation angle and the reference rotation angle; determining the detection result of the first rotation angle as normal, in response to the second angle difference being smaller than a second angle threshold; and determining the detection result as abnormal, in response to the second angle difference being larger than or equal to the second angle threshold

In some embodiments, a seventh difference between the first rotation angle and the reference rotation angle may be determined first. If the seventh difference is non-negative, it may be determined as the second angle difference; otherwise, if the seventh difference is negative, the opposite number of the seventh difference may be determined as the second angle difference.

In some embodiments, the second angle threshold may be a value set in advance according to experience. For example, the second angle threshold may be 0.11, 0.12, 0.13, or the like. If the second angle difference is smaller than the second angle threshold, it indicates that the first rotation angle is the same or approximately the same as the reference rotation angle, and the detection result of the first rotation angle is normal; otherwise, if the second angle difference is larger than or equal to the second angle threshold, it indicates that the first rotation angle is different from the reference rotation angle, and the detection result of the first rotation angle is determined to be abnormal.

Through the above-mentioned steps S101-S105, for the first identification of the to-be-detected object in the to-be-detected image, it first determines the third rotation angle set corresponding to the first identification from the M second rotation angle set of the first dictionary, and then determines the reference rotation angle corresponding to the first identification from each third rotation angle set, in response to the number of elements of the third rotation angle set being larger than the first number threshold. Since the third rotation angle set includes third rotation angles, it is equivalent to determine the reference rotation angle corresponding to the first identification from the plurality of third rotation angles when the number of the third rotation angles is larger than the first number threshold, thereby improving the accuracy of the reference rotation angle. Based on this, the reference rotation angle is used to detect anomalies of the first rotation angle. In which, the first rotation angle is the rotation angle of the detection box of the to-be-detected object in the to-be-detected image. Since the reference rotation angle has the characteristics of high accuracy, it is possible to achieve efficient and accurate anomaly detection based on the reference rotation angle, thereby identifying whether the first rotation angle is normal or not through anomaly detection, and providing accurate data supports for subsequent applications such as autonomous driving, navigation, or augmented reality.

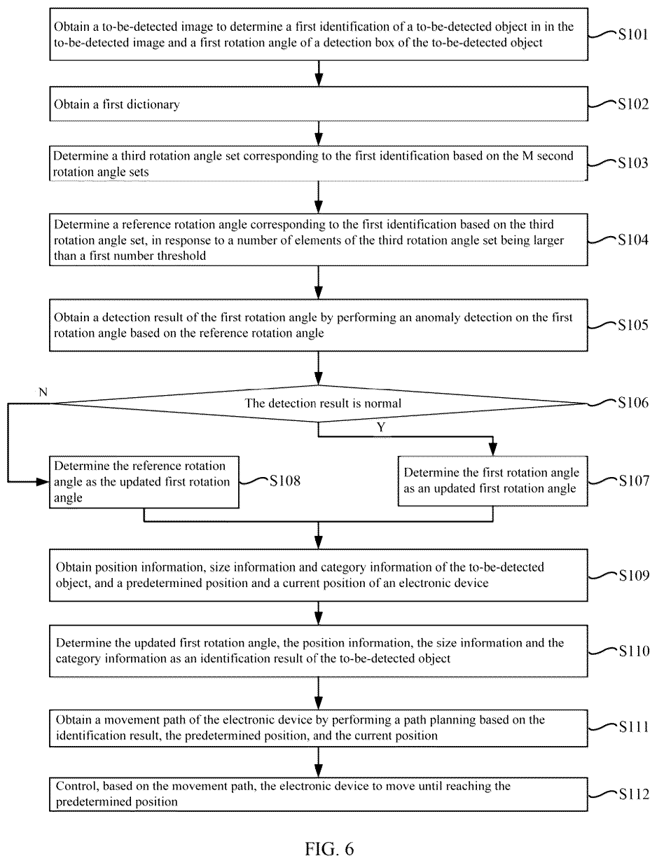

FIG. 6 is a flow chart of the second example of anomaly detection method according to an embodiment of the present disclosure. As shown in FIG. 6, in some embodiments, after the above-mentioned step S105, the anomaly detection method may further perform the following steps S106-S112, which will be described in detail below.

S106: determining whether the detection result is normal.

In some embodiments, if the detection result is normal, it indicates that the first rotation angle is correct and no correction is required, then proceeds to step S107; otherwise, if the detection result is abnormal, it indicates that the detection result is abnormal, that is, the first rotation angle is not correct and correction is required, then proceeds to step S108.

S107: determining the first rotation angle as an updated first rotation angle, and proceeding to step S109.

In which, it indicates that the first rotation angle is correct, that is, the first rotation angle does not need to be corrected. Then, the first rotation angle is kept unchanged, that is, the first rotation angle is determined as the updated first rotation angle.

S108: determining the reference rotation angle as the updated first rotation angle.

In which, it indicates that the first rotation angle is incorrect, that is, the first rotation angle needs to be corrected, and the reference rotation angle is determined as the updated first rotation angle.

S109: obtaining position information, size information and category information of the to-be-detected object, and a predetermined position and a current position of an electronic device.

In some embodiments, position information, dimension information, and category information of the to-be-detected object may be obtained through the above-mentioned 3D object detection method. In which, the position information may be the three-dimensional coordinates of the to-be-detected object in three-dimensional space; the dimension information may refer to the shape of the to-be-detected object which may be represented by, for example, length, width, and height; and the category information may refer to the type of the to-be-detected object, for example, pedestrian.

In some embodiments, the predetermined position may be a position set in advance. The predetermined position may be three-dimensional coordinates, which refers to the target position of the electronic device, for example, destination coordinates. The current position of the electronic device refers to the coordinates of the current position of the electronic device.

S110: determining the updated first rotation angle, the position information, the size information and the category information as an identification result of the to-be-detected object.

In some embodiments, it may substitute the first rotation angle in a 3D object detection result with the updated first rotation angle. The 3D object detection result may include position information, dimension information, and category information, thereby obtaining the identification result of the to-be-detected object.

S111: obtaining a movement path of the electronic device by performing a path planning based on the identification result, the predetermined position, and the current position.

In some embodiments, it may construct a (static or dynamic) map based on the identification result, the predetermined position, and the current position to mark the passable area and the obstacle position, then determine an optimal path from the current position to the target point, thereby obtaining a movement path of the electronic device.

S112: controlling, based on the movement path, the electronic device to move until reaching the predetermined position.

In some embodiments, the movement path may be tracked using a control algorithm. The control algorithm may adjust the speed and direction for a proportional-integral-derivative (PID) controller or a model predictive control (MPC) until the electronic device reaches the predetermined position.

Through the above-mentioned steps S106-S112, when the detection result is abnormal, the reference rotation angle is used as the updated first rotation angle, so that the detection status of the electronic device can be quickly adjusted to reduce execution deviations caused by error judgments, and the position information, dimension information and, category information of the to-be-detected object are comprehensively considered to help in improving the identification accuracy of the to-be-detected object and ensure the correctness of the basic data as the basis for path planning. By using the updated first rotation angle and the object information of the to-be-detected object that are updated in real time, the movement path of the electronic device can be better planned, unnecessary path detours can be reduced, and the efficiency of reaching the predetermined position can be improved. The real-time identification results are combined with path planning to allow the electronic device to achieve efficient navigation in complex or changing environments. When detecting anomalies, the electronic device can automatically adjust the first rotation angle and path planning to avoid interruption of system operation due to a single point of failure. With the help of the dimension information and the category information, the electronic device can adapt to processing the to-be-detected objects of different dimensions and categories, and make it more applicable. Based on the updated first rotation angle and accurate identification results, the movement path of the electronic device can be more in line with actual needs and reduces target deviations caused by path errors. In this manner, the device is controlled to move based on optimized paths to ensure that it can finally reach the predetermined position accurately, thereby avoiding repeated operations.

An example of applying the above-mentioned method in one practical application scenario will be described below.

As an important research direction in the field of computer vision, 3D object detection has got widespread attentions and applications in recent years. 3D object detection refers to the technology of detecting and positioning objects in three-dimensional space. 3D object detection obtains three-dimensional point cloud data or image information through different sensors (e.g., lidar and camera), thereby recognizing and positioning the target objects in its environment. This technology is widely used in the fields such as autonomous driving, robot navigation, augmented reality, and the like, providing these fields with more accurate and comprehensive environmental perception capabilities.

With the rapid development of autonomous driving and robotics, the accuracy and real-time requirements for environmental perception are becoming increasingly high. Although traditional 2D object detection can identify objects in an image and give their position information, in a real three-dimensional world, objects have three-dimensional shapes and postures, so 2D detection cannot meet the requirements of these applications for accuracy and comprehensiveness. Since 3D object detection can provide more accurate and comprehensive object position and shape information, it has become an important technical support in these fields.

In this embodiment, for the object with the same tracking ID, in the case that most of the rotation angles are correct while a small number of them are mutations, an anomaly detection method is proposed to correct the wrong rotation angle, thereby solving the problem of inaccurate angles of the detection box output by 3D object detection.

In some embodiments, the anomaly detection may be performed on the output content or output results of 3D object detection. Based on this, 3D object detection and 3D multi-object tracking may also be performed before the anomaly detection is performed.

For 3D object detection, taking Bird Eye View Fusion (BEVFusion) algorithm as an example, the input of the BEVFusion algorithm mainly includes raw data from different sensors that may include camera and light detection and ranging (lidar). In which, the input data may include camera images and lidar point clouds. The camera images refer to red, green, and blue (RGB) images of multiple viewing angles (e.g., front, back, left, and right). The camera images provide rich semantic information. Lidar point cloud refers to point cloud data in three-dimensional space, which contains the geometric shape and position information of objects.

In some embodiments, the core of the BEVFusion algorithm is to fuse data from different sensors into a unified representation space that may be in a bird's-eye view (BEV). Then, 3D object detection is performed, where the 3D object detection may include data preprocessing, feature extraction, data fusion, and BEV feature encoding.

In some embodiments, the data preprocessing may include: first, preprocessing the camera image and the lidar point cloud, including coordinate transformation, normalization, and the like, to ensure that the data adapts to the representation space of the BEV; second, performing distortion correction and other operations on the camera images; finally, performing filter, downsample, and other processing on the lidar point cloud.

In some embodiments, the feature extraction may refer to extracting features from the preprocessed data using deep learning models such as convolutional neural network (CNN) or Transformer. The feature extraction may include: first, extracting a semantic feature map from the camera image through CNN; then, extracting geometric features from the lidar point cloud through point cloud processing network (e.g., PointNet++).

In some embodiments, the data fusion may be projecting the features from different sensors into the BEV space, which may include: first, for camera features, projecting each camera feature pixel into a ray in three-dimensional space through a camera-BEV conversion process to disperse along the ray into multiple discrete points so as to form a camera feature point cloud; then, for lidar features, flattening sparse point cloud along the height dimension by directly projecting from liar to BEV; finally, aggregating the feature point clouds of camera and lidar into a unified BEV grid using BEV pooling operation.

In some embodiments, the unified BEV features may be further processed using a convolution-based BEV encoder to mitigate local dislocations between different features.

Based on this, a header of specific task (e.g., a detection header) may be applied to the fused BEV feature map to perform 3D object detection, thereby outputting information such as the position, dimension and category of the detected 3D object.

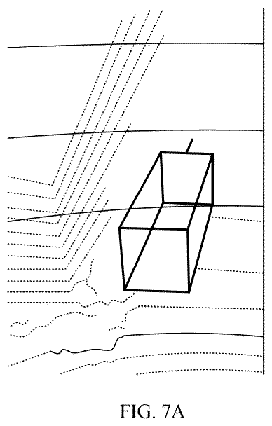

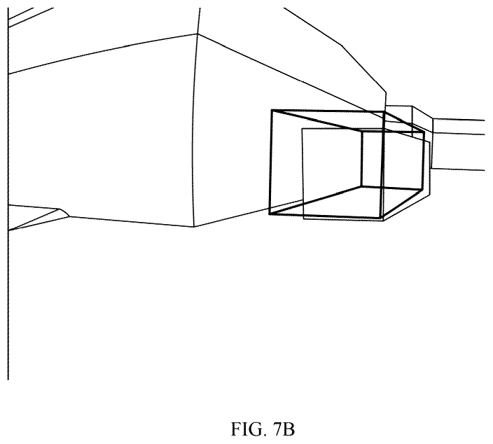

FIG. 7A is a schematic diagram of displaying a detection box in a lidar point cloud according to an embodiment of the present disclosure; and FIG. 7B is a schematic diagram of displaying a detection box in a camera image according to an embodiment of the present disclosure. As shown in FIG. 7A and FIG. 7B, in some embodiments, the model may output the 3D detection boxes of all the detected objects, which have different visual effects on the lidar point cloud and the camera image.

In other embodiments, each 3D object detection box may be represented by the following values:
first, the position of the center point of the detection box may be represented by 3D coordinates, for example, (x, y, z);
second, the dimension of the detection box may be represented by the length, width, and height, for example (l, w, h);
third, the orientation angle of the detection box, that is, the yaw angle of the detection box which can also be called the rotation angle of the detection box, may be noted as yaw;
fourth, the category such as human, car, truck, or the like; and
fifth, the confidence.

For 3D multi-object tracking, taking the Kalman filtering method as an example, Kalman filtering-based 3D multi-object tracking is a method of continuously tracking multiple three-dimensional objects in a complex environment.

In some embodiments, when performing 3D multi-object tracking, the input may include the output result of 3D object detection and initial status information. In which, the output result of 3D object detection may include three-dimensional object detection box information of each frame, that is, the output result of the detection model performing 3D object detection that includes the coordinates of the center point, dimension, orientation angle (i.e., rotation angle), category, and confidence of the object detection box, and may further include the timestamp of the current moment which is accurate to milliseconds (ms). For each newly detected object, its status information needs to be initialized. The initial status information may include position, speed, acceleration, and the like. The position in the initial status information may be directly set according to the detection data, the speed and acceleration in the initial status information may be default to 0.

In some embodiments, the processing steps of the 3D multi-object tracking may include trajectory initialization, Kalman filter prediction, data association, and Kalman filter update. In which, for trajectory initialization, it refers to initializing its trajectory for each newly detected object, including setting Kalman filter parameters such as initial state estimate, transfer matrix, observation matrix, process noise covariance matrix, and observed noise covariance matrix. For the Kalman filter prediction, a constant rate Kalman filtering algorithm (or other appropriate Kalman filtering variant) may be used to predict the object state (e.g., position and speed) at the current moment based on the motion model and the state estimate of the previous moment of the object. In addition, in the prediction process, the dynamic information and process noise of the system may be taken into account to deal with uncertainty in the motion of the object. For the data association, the Hungarian algorithm may be used to associate the predicted trajectory with the three-dimensional object detection data of the current frame. In some embodiments, other data association algorithms such as intersection over union (IOU) matching may be used. The data association is to solve the identity identifying problem of the same object between different frames, which determines the tracked object to which the detection data belongs by comparing the similarity between the predicted trajectory and the observed data (in, for example, position, size, shape, and the like). For the Kalman filter update, based on the results of data association, the predicted state and observation data are weighted and averaged by using the Kalman gain to obtain the optimal state estimate of the current moment, and the prediction information and observation information are combined in the update process to minimize estimation errors.

In some embodiments, for all input detection boxes, a tracking ID of each detection box, the speed in the x-axis direction, and the speed in the y-axis direction are output through 3D multi-object tracking. In which, the tracking ID corresponds to the first identification or the second identification in other embodiments.

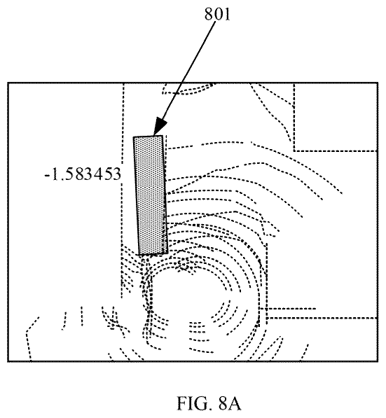

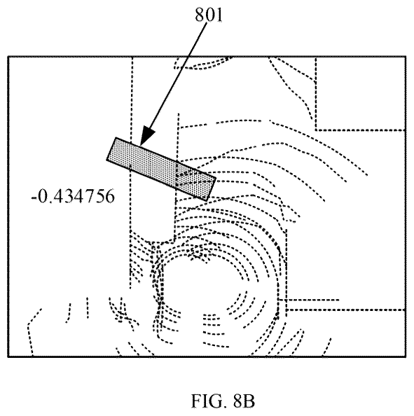

FIG. 8A is a schematic diagram of displaying a detection box in a correct rotation angle according to an embodiment of the present disclosure. As shown in FIG. 8A, there is a visual result of a top-view angle detection box of object 801 that has the category of object on the point cloud, where the rotation angle of object 801 is −1.583453. It can be seen that the detection result and the point cloud profile are fit, so the detection box can be considered as correct.

FIG. 8B is a schematic diagram of displaying a detection box in a wrong rotation angle according to an embodiment of the present disclosure. As shown in FIG. 8B, object 8011 has the category of object, where the rotation angle of object 801 is −0.434756. The detection boxes in FIG. 8A and FIG. 8B are the detection boxes of the same object at different times. From FIG. 8B, it can be seen that the angle of the detection box has more deviation than the actual point cloud, so it can be considered as an error detection box. In which, the object corresponds to the to-be-detected object in other embodiments.

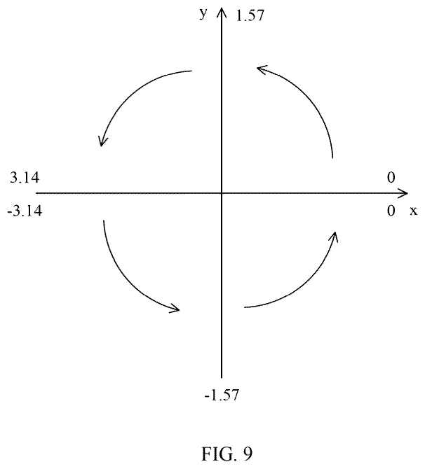

In this embodiment, for the object of the same tracking ID, when the rotation angle is correct most of the time and a small part of them mutate, the wrong rotation angle may be identified and corrected through the following steps 1-8, which will be described below.
Step 1: create a new dictionary 1. Dictionary 1 is initially empty, which is to store all the tracking IDs that appear and the corresponding detection boxes at different times. In which, the keyword of Dictionary 1 is the tracking ID, and its value is the detection boxes at different moments that correspond to that tracking ID. Dictionary 1 corresponds to the first dictionary in other embodiments, and the detection box corresponds to the second rotation angle set in other embodiments.
Step 2: traverse all the detection boxes of the current frame and determine how many times the tracking ID of the detection box appears. For example, if the tracking ID of a target box is 0, it first looks for whether the tracking ID of 0 already exists in Dictionary 1. If so, the current detection box will continue to be merged into the value corresponding to the tracking ID of 0, and the number of the detection boxes of different moments that are stored corresponding to that ID is obtain, where C++ programming language may be used to directly obtain it; otherwise, a new key-value pair is created with the keyword of 0 and the value of the corresponding detection box. The current detection box corresponds to the first rotation angle of the detection box of the to-be-detected object in other embodiments.
Step 3, no processing will be performed if the number of the detection boxes stored for the current tracking ID in Dictionary 1 that is obtained in step 2 is less than 10, that is, the process is ended; otherwise, if the number of the detection boxes stored for the current tracking ID is between 10 and 15, it proceeds to step 4.
Step 4, taking the tracking ID of 0 as an example, assuming that the tracking ID of 0 in Dictionary 1 has stored more than 10 historical detection boxes at different moments, the distribution of rotation angles in these historical detection boxes will be counted by the steps including: traversing, from the 0-th detection box, all the historical detection boxes of the tracking ID of 0 to determine the size of the included angle of the 0-th detection box and the other 9 detection boxes. FIG. 9 is a schematic diagram of the distribution of the angles of a detection box according to an embodiment of the present disclosure. As shown in FIG. 9, the distribution of the angle of each detection box will locate between 0 and 3.14, or between −3.14 and 0. Based on this, assuming that the rotation angle of the 0-th detection box is 1.57 and that of the 1-st detection box is 1.6, the included angle between the two is 0.03. The included angle corresponds to the first angle difference in other embodiments.

In some embodiments, the included angle between any detection box and the other of the detection boxes may be determined using an equation of.

$$included angle = min ( abs ( a - b ) , 3.14 - abs ( a - b ) ) , \{ \begin{matrix}a = a + 3.14 if a < 0 \\ b = b + 3.14 if b < 0\end{matrix} \qquad ( 4 )$$

In the forgoing equation (4), a represents the angle of the detection box under the first timestamp, b represents the angle of the detection box under the second timestamp, abs(.) represents the absolute value, and min(.) represents the smaller value, and the included angle represents the angle difference of two detection boxes under different timestamps.

In this embodiment, regardless of the direction of the angle, the included angle between the straight lines where they located is considered, for example, if the angles of two detection boxes are 1.57 and −1.57, the included angle is considered to be 0.
Step 5, as in the foregoing examples, since the included angle between all the detection boxes of the tracking ID of 0 and the other detection boxes has been determined in step 4, the number of the included angles of each detection box and the other detection boxes that are within the first angle threshold (e.g., 0.15) are counted, and the detection box with the largest number of the included angles is considered as the best detection box for the tracking ID to store in new Dictionary 2. In which Dictionary 2 is used to store the best detection box for each tracking ID. In this embodiment, for one tracking ID, there is only one best detection box. The best detection box corresponds to the reference rotation angle in other embodiments.
Step 6: determine the included angle between the angle of the detection box angle of the current timestamp and that of the best detection box. If the included angle is less than the second angle threshold (e.g., 0.12), no processing will be performed; otherwise, if the angle is larger than the second angle threshold, the angle of the current detection box is updated to the angle of the best detection box. The included angle between the angle of the detection box of the current timestamp and that of the best detection box corresponds to the second angle difference in other embodiments.
Step 7, if the number of the detection boxes of the tracking ID stored in Dictionary 1 is larger than 15, it is necessary to further determine whether the number of the detection boxes is larger than 20. If so, the detection box of the tracking ID with the earliest timestamp is deleted, so that the maximum number of the detection boxes does not exceed 20, and then it proceeds to steps 4-6; otherwise, if the number of the detection boxes is less than or equal to 20, it is considered that the number of the detection boxes is sufficient at this time, the first angle threshold may be adjusted to 0.1, and continues to proceed steps 4-6.
Step 8: after all the detection boxes of the current timestamp are traversed, it needs to check the timestamp of each tracking ID in Dictionary 1. If the difference between that timestamp and the timestamp of the current moment exceeds the time threshold (e.g., 2 seconds), the tracking ID and all of its detection boxes are deleted.

Through the above-mentioned steps 1-8, the mutation problem of the object angles can be optimized.

It can be understood that in this embodiment, the to-be-detected image, the first dictionary, the position information of the to-be-detected object, the dimension information of the to-be-detected object, the category information of the to-be-detected object, the predetermined position, the current position of the electronic device, the second dictionary, the first timestamp, the second timestamp, and other related data are involved, and the collection, use and processing of such data must comply with relevant laws, regulations and standards.

The following will continue to describe the exemplary structure of the above-mentioned anomaly detection apparatus 455 as a software module. In some embodiments, as shown in FIG. 2, the software module stored in the anomaly detection apparatus 455 of the storage 450 may include:

the first obtaining module 4551 configured to obtain the to-be-detected image to determine a first identification of a to-be-detected object from the to-be-detected image and a first rotation angle of a detection box of the to-be-detected object; the second obtaining module 4552 configured to obtain a first dictionary, where the first dictionary includes M second identifications, M second rotation angle set each corresponding to each of the second identifications, and the second rotation angle set includes second rotation angles corresponding to different timestamps; the first determination module 4553 configured to determine a third rotation angle set corresponding to the first identification based on the M second rotation angle sets; the second determination module 4554 configured to determine a reference rotation angle corresponding to the first identification based on the third rotation angle set, in response to a number of elements of the third rotation angle set being larger than a first number threshold; and the detection module 4555 configured to obtain a detection result of the first rotation angle by performing an anomaly detection on the first rotation angle based on the reference rotation angle.

In some embodiments, the second determination module 4554 may be further configured to:
determine a first angle difference between each of third rotation angles in the third rotation angle set and the other of the third rotation angles in the third rotation angle set; determine a first number of the first angle differences smaller than a first angle threshold to take as an effective value of the third rotation angle; and determine the third rotation angle with the maximum effective value in the third rotation angle set to take as a reference rotation angle corresponding to the first identification.

In some embodiments, the second determination module 4554 may be further configured to:
determining a first difference between the third rotation angle and the other of the third rotation angles to determine a first absolute value of the first difference, in response to the third rotation angle and the other of the third rotation angles being both non-negative; determining a second difference between a predetermined angle and the first absolute value; and determining the smaller of the first absolute value and the second difference as the first angle difference.

In some embodiments, the second determination module 4554 may be further configured to:
determining a first sum of the third rotation angle and the predetermined angle, and a second sum of the other of the third rotation angles and the predetermined angle, in response to the third rotation angle and the other of the third rotation angle being both negative; determining a third difference between the first sum and the second sum, and determining a second absolute value of the third difference; determining a fourth difference between the predetermined angle and the second absolute value; and determining the smaller between the second absolute value and the fourth difference as the first angle difference.

In some embodiments, the second determination module 4554 may be further configured to:
determining a third sum of a negative number and the predetermined angle in response to one of the third rotation angle and the other of the third rotation angles being the negative number, and the other being a non-negative number; determining a fifth difference between the third sum and the non-negative number, and determining a third absolute value of the fifth difference; determining a sixth difference between the predetermined angle and the third absolute value; an determining the smaller between the third absolute value and the sixth difference as the first angle difference.

In some embodiments, the detection module 4555 may be further configured to:
determining a second angle difference between the first rotation angle and the reference rotation angle; determining the detection result of the first rotation angle as normal, in response to the second angle difference being smaller than a second angle threshold; and determining the detection result as abnormal, in response to the second angle difference being larger than or equal to the second angle threshold

In some embodiments, the software module stored in the anomaly detection apparatus 455 of the storage 450 may further include:
determining the first rotation angle as an updated first rotation angle, in response to the detection result being normal; and
determining the reference rotation angle as the updated first rotation angle, in response to the detection result being abnormal.

In some embodiments, the software module stored in the anomaly detection apparatus 455 of the storage 450 may further include:
a third obtaining module configured to obtain position information, size information and category information of the to-be-detected object, and a predetermined position and a current position of an electronic device; a fifth determination module configured to determine the updated first rotation angle, the position information, the size information and the category information as an identification result of the to-be-detected object; a path planning module configured to obtain a movement path of the electronic device by performing a path planning based on the identification result, the predetermined position, and the current position; and a control module configured to control, based on the movement path, the electronic device to move until reaching the predetermined position.

In some embodiments, the software module stored in the anomaly detection apparatus 455 of the storage 450 may further include:
a fourth obtaining module configured to obtaining a second dictionary, where the second dictionary corresponds to a timestamp before obtaining the to-be-detected image; a first storage module configured to storing the first identification as a keyword in the second dictionary; and a second storage module configured to obtaining the first dictionary by storing the first rotation angle as a value in the second dictionary.

In some embodiments, the software module stored in the anomaly detection apparatus 455 of the storage 450 may further include:
a fifth obtaining module configured to obtaining, for each of the second identifications, a first timestamp that corresponds to each of the second rotation angles corresponding to the second identification, in response to a second number of the second rotation angles corresponding to the second identification being larger than a second number threshold; a sorting module configured to obtaining sorted rotation angles by sorting the second rotation angles in an order of the first timestamp from small to large; a first deletion module configured to obtaining the first dictionary after updated by deleting the first L second rotation angles in the sorted rotation angles from the first dictionary, where L is a positive integer.

In some embodiments, the software module stored in the anomaly detection apparatus 455 of the storage 450 may further include:
a sixth obtaining module configured to obtain, for each of the second identifications, a second timestamp that corresponds to each of the second rotation angles corresponding to the second identification; a sixth determination module configured to determine a maximum timestamp among the second timestamps corresponding to the second rotation angles; and a second deletion module configured to obtain the first dictionary after updated by deleting the second identification and the second rotation angles corresponding to the second identification from the first dictionary, in response to a time interval between the maximum timestamp and a current timestamp being larger than a time threshold.

The embodiments of the present disclosure further provide a computer program product or a computer program that includes computer-executable instructions stored in a computer-readable storage medium. A processor of a computer equipment reads the computer-executable instructions from the computer-readable storage medium and executes the computer-executable instructions so that the computer equipment performs the above-mentioned anomaly detection method.

The embodiments of the present disclosure further provide a computer-readable storage medium storing computer-executable instructions. The above-mentioned anomaly detection method (e.g., the anomaly detection method as shown in FIG. 3 and FIG. 6) is executed by a processor when the processor executes the computer-executable instructions.

In some embodiments, the computer-readable storage medium may be a storage such as FRAM, ROM, PROM, EPROM, EEPROM, flash memory, magnetic surface memory, optical disk, or CD-ROM, and may also be various equipment including one of the forgoing storages or any combination of them.

In some embodiments, the computer-executable instructions may be implemented in the form of a program, software, software module, script or codes in any form of programming language (including compiled or interpreted languages, or declarative or procedural languages), and may be deployed in any form, including being deployed as a standalone program, a module, a component, a subroutine, or other unit suitable for use in a computing environment.

As an example, the computer-executable instructions may, but do not necessarily correspond to a file in the file system, and may be stored in a part of the file storing other programs or data, for example, in one or more scripts of a Hyper Text Markup Language (HTML) document, or stored in a single file dedicated to the program in question, or a plurality of collaborative files (e.g., files that store one or more modules, subroutines, or code parts).

As an example, the computer-executable instructions may be deployed to execute on one computing device, or on a plurality of computing devices located at one location, or a plurality of computing devices distributed across multiple locations and interconnected over a communication network.

The foregoing are only the embodiments of the present disclosure and are not intended to limit the scope of the protection of the present disclosure. Any modification, equivalent substitution, improvement, and the like made within the spirit and scope of the present disclosure are included within the scope of the protection of the present disclosure.

What is claimed is:

1. A method for detecting anomaly in sensor data, comprising:
obtaining the sensor data to determine a first identification of a to-be-detected object from the sensor data and a first rotation angle of a detection box of the to-be-detected object;
obtaining a first dictionary, wherein the first dictionary includes a plurality of identifications, a plurality of second rotation angle set each corresponding to each of the second identifications, and the second rotation angle set includes second rotation angles corresponding to different timestamps;
determining a third rotation angle set corresponding to the first identification based on the second rotation angle sets;
determining a reference rotation angle corresponding to the first identification based on the third rotation angle set, in response to a number of elements of the third rotation angle set being larger than a first number threshold; and
obtaining a detection result of the first rotation angle by performing an anomaly detection on the first rotation angle based on the reference rotation angle.

2. The method of claim 1, wherein determining the reference rotation angle corresponding to the first identification based on the third rotation angle set comprises:
determining a first angle difference between each of third rotation angles in the third rotation angle set and the other of the third rotation angles in the third rotation angle set;
determining a first number of the first angle differences smaller than a first angle threshold to take as an effective value of the third rotation angle; and
determining the third rotation angle with the maximum effective value in the third rotation angle set to take as a reference rotation angle corresponding to the first identification.

3. The method of claim 2, wherein determining the first angle difference between each of third rotation angles in the third rotation angle set and the other of the third rotation angles in the third rotation angle set comprises:
determining a first difference between the third rotation angle and the other of the third rotation angles to determine a first absolute value of the first difference, in response to the third rotation angle and the other of the third rotation angles being both non-negative;
determining a second difference between a predetermined angle and the first absolute value; and
determining the smaller of the first absolute value and the second difference as the first angle difference.

4. The method of claim 3, further comprising:
determining a first sum of the third rotation angle and the predetermined angle, and a second sum of the other of the third rotation angles and the predetermined angle, in response to the third rotation angle and the other of the third rotation angle being both negative;
determining a third difference between the first sum and the second sum, and determining a second absolute value of the third difference;
determining a fourth difference between the predetermined angle and the second absolute value; and
determining the smaller between the second absolute value and the fourth difference as the first angle difference.

5. The method of claim 3, further comprising:
determining a third sum of a negative number and the predetermined angle in response to one of the third rotation angle and the other of the third rotation angles being the negative number, and the other being a non-negative number;
determining a fifth difference between the third sum and the non-negative number, and determining a third absolute value of the fifth difference;
determining a sixth difference between the predetermined angle and the third absolute value; and
determining the smaller between the third absolute value and the sixth difference as the first angle difference.

6. The method of claim 1, wherein obtaining the detection result of the first rotation angle by performing the anomaly detection on the first rotation angle based on the reference rotation angle comprises:
determining a second angle difference between the first rotation angle and the reference rotation angle;
determining the detection result of the first rotation angle as normal, in response to the second angle difference being smaller than a second angle threshold; and
determining the detection result as abnormal, in response to the second angle difference being larger than or equal to the second angle threshold.

7. The method of claim 6, further comprising:
determining the first rotation angle as an updated first rotation angle, in response to the detection result being normal; and
determining the reference rotation angle as the updated first rotation angle, in response to the detection result being abnormal.

8. The method of claim 7, further comprising:
obtaining position information, size information and category information of the to-be-detected object, and a predetermined position and a current position of an electronic device; and
determining the updated first rotation angle, the position information, the size information and the category information as an identification result of the to-be-detected object;
obtaining a movement path of the electronic device by performing a path planning based on the identification result, the predetermined position, and the current position; and
controlling, based on the movement path, the electronic device to move until reaching the predetermined position.

9. The method of claim 1, further comprising:
obtaining a second dictionary, wherein the second dictionary corresponds to a timestamp before obtaining the sensor data;
storing the first identification as a keyword in the second dictionary; and
obtaining the first dictionary by storing the first rotation angle as a value in the second dictionary.

10. The method of claim 1, further comprising:
obtaining, for each of the second identifications, a first timestamp that corresponds to each of the second rotation angles corresponding to the second identification, in response to a second number of the second rotation angles corresponding to the second identification being larger than a second number threshold;
obtaining sorted rotation angles by sorting the second rotation angles in an order of the first timestamp from small to large; and
obtaining the first dictionary after updated by deleting the first L second rotation angles in the sorted rotation angles from the first dictionary, wherein L is a positive integer.

11. The method of claim 1, further comprising:
obtaining, for each of the second identifications, a second timestamp that corresponds to each of the second rotation angles corresponding to the second identification;
determining a maximum timestamp among the second timestamps corresponding to the second rotation angles; and
obtaining the first dictionary after updated by deleting the second identification and the second rotation angles corresponding to the second identification from the first dictionary, in response to a time interval between the maximum timestamp and a current timestamp being larger than a time threshold.

12. A computer equipment, comprising:
a processor;
a memory coupled to the processor; and
one or more computer programs stored in the memory and executable on the processor;
wherein, the one or more computer programs comprise:
instructions for obtaining sensor data to determine a first identification of a to-be-detected object from the sensor data and a first rotation angle of a detection box of the to-be-detected object;
instructions for obtaining a first dictionary, wherein the first dictionary includes a plurality of identifications, a plurality of second rotation angle set each corresponding to each of the second identifications, and the second rotation angle set includes second rotation angles corresponding to different timestamps;
instructions for determining a third rotation angle set corresponding to the first identification based on the second rotation angle sets;
instructions for determining a reference rotation angle corresponding to the first identification based on the third rotation angle set, in response to a number of elements of the third rotation angle set being larger than a first number threshold; and
instructions for obtaining a detection result of the first rotation angle by performing an anomaly detection on the first rotation angle based on the reference rotation angle.

13. The computer equipment of claim 12, wherein determining the reference rotation angle corresponding to the first identification based on the third rotation angle set comprises:
determining a first angle difference between each of third rotation angles in the third rotation angle set and the other of the third rotation angles in the third rotation angle set;
determining a first number of the first angle differences smaller than a first angle threshold to take as an effective value of the third rotation angle; and
determining the third rotation angle with the maximum effective value in the third rotation angle set to take as a reference rotation angle corresponding to the first identification.

14. The computer equipment of claim 13, wherein determining the first angle difference between each of third rotation angles in the third rotation angle set and the other of the third rotation angles in the third rotation angle set comprises:
determining a first difference between the third rotation angle and the other of the third rotation angles to determine a first absolute value of the first difference, in response to the third rotation angle and the other of the third rotation angles being both non-negative;
determining a second difference between a predetermined angle and the first absolute value; and
determining the smaller of the first absolute value and the second difference as the first angle difference.

15. The computer equipment of claim 14, further comprising:
determining a first sum of the third rotation angle and the predetermined angle, and a second sum of the other of the third rotation angles and the predetermined angle, in response to the third rotation angle and the other of the third rotation angle being both negative;
determining a third difference between the first sum and the second sum, and determining a second absolute value of the third difference;
determining a fourth difference between the predetermined angle and the second absolute value; and
determining the smaller between the second absolute value and the fourth difference as the first angle difference.

16. The computer equipment of claim 14, further comprising:
determining a third sum of a negative number and the predetermined angle in response to one of the third rotation angle and the other of the third rotation angles being the negative number, and the other being a non-negative number;
determining a fifth difference between the third sum and the non-negative number, and determining a third absolute value of the fifth difference;
determining a sixth difference between the predetermined angle and the third absolute value; and
determining the smaller between the third absolute value and the sixth difference as the first angle difference.

17. The computer equipment of claim 12, wherein obtaining the detection result of the first rotation angle by performing the anomaly detection on the first rotation angle based on the reference rotation angle comprises:
determining a second angle difference between the first rotation angle and the reference rotation angle;
determining the detection result of the first rotation angle as normal, in response to the second angle difference being smaller than a second angle threshold; and
determining the detection result as abnormal, in response to the second angle difference being larger than or equal to the second angle threshold.

18. The computer equipment of claim 17, further comprising:
determining the first rotation angle as an updated first rotation angle, in response to the detection result being normal; and
determining the reference rotation angle as the updated first rotation angle, in response to the detection result being abnormal.

19. The computer equipment of claim 18, further comprising:
obtaining position information, size information and category information of the to-be-detected object, and a predetermined position and a current position of an electronic device; and
determining the updated first rotation angle, the position information, the size information and the category information as an identification result of the to-be-detected object;
obtaining a movement path of the electronic device by performing a path planning based on the identification result, the predetermined position, and the current position; and
controlling, based on the movement path, the electronic device to move until reaching the predetermined position.

20. A non-transitory computer-readable storage medium for storing one or more computer programs, wherein the one or more computer programs comprise:
instructions for instructions for obtaining sensor data to determine a first identification of a to-be-detected object from the sensor data and a first rotation angle of a detection box of the to-be-detected object;
instructions for obtaining a first dictionary, wherein the first dictionary includes a plurality of identifications, a plurality of second rotation angle set each corresponding to each of the second identifications, and the second rotation angle set includes second rotation angles corresponding to different timestamps;
instructions for determining a third rotation angle set corresponding to the first identification based on the second rotation angle sets;
instructions for determining a reference rotation angle corresponding to the first identification based on the third rotation angle set, in response to a number of elements of the third rotation angle set being larger than a first number threshold; and
instructions for obtaining a detection result of the first rotation angle by performing an anomaly detection on the first rotation angle based on the reference rotation angle.
